(19) United States
(12) Patent Application Publication
(10) Pub. No.: US 2024/0191910 A1
(43) Pub. Date: Jun. 13, 2024

(54) METHOD FOR CONTROLLING AN INSTALLATION CONNECTED TO A GEOTHERMAL SOURCE FOR SUPPLYING THERMAL ENERGY TO AT LEAST ONE BUILDING, AND REGULATING SYSTEM AND INSTALLATION RELATING THERETO

(71) Applicant: ACCENTA, Boulogne Billancourt (FR)

(72) Inventors: Pierre TREMOLIERES, Orsay (FR); Philippe BRUAND, Le Vesinet (FR)

(21) Appl. No.: 18/550,748

(22) PCT Filed: Mar. 16, 2022
(86) PCT No.: PCT/EP2022/056861

§ 371 Date: Sep. 15, 2023

(30) Foreign Application Priority Data
Mar. 19, 2021 (FR) 2102800

(51) Int. Cl. F24T 50/00; F24D 19/10

(52) U.S. Cl. CPC F24T 50/00; F24D 19/10; F24D 2200/11; F24T 2201/00

(57) ABSTRACT

An installation including at least one source of geothermal energy for geothermal storage, at least one other energy source, and equipment for converting and distributing energy. The geothermal source includes probes installed in the medium that permit heat exchange between the geothermal medium and a heat-transport fluid passing through the probes. The method involves defining a forecast trajectory (TP) for the temperature of the geothermal medium over time, evaluating the temperature of the geothermal medium, making an adjustment to the thermal power exchanged between the geothermal medium and the heat-transport fluid which on leaving the probe has a temperature (TW), in the direction of making the temperature of the geothermal medium consistent with the forecast trajectory. The mean (TM) of the forecast trajectory (TP) is stable and preferably exhibits, with respect to the ground temperature (TN) a differential causing an annual thermal flux between the natural ground and the medium.

The present invention relates to a method for controlling an installation connected to a geothermal source for supplying thermal energy to at least one building.

The present invention also relates to an installation in which this method is implemented.

The present invention further relates to a regulating system implementing the method and/or integrated in the installation.

The invention relates quite particularly but non-limitatively to relatively large property developments, for example apartment buildings, groups of buildings, industrial complexes, hospital centres, commercial centres, hotels or hotel-type complexes, school or university campuses, etc.

### STATE OF THE ART

Installations are known in the building sector making it possible to provision energy from several sources, for example gas or electricity public distribution networks, geothermal probes, solar heat collectors, photovoltaic solar panel collectors, aerothermal solar collectors, or others. These known installations comprise various items of equipment for transforming the collected energy and for using it, for example, heat pumps, Joule-effect heating devices, air-conditioners, boilers, etc. It is also known to implement a method that regulates the installation by weighting the application of the different sources and the different items of equipment as a function of the needs and according to economic or other criteria.

The documents FR 2960099 A1, US 2008/092875 A1, WO 2015/014951 A2, EP 3012539 A1, EP 2141419 A1, FR 3065516 A1, EP 1987298 B1, DE 102010033909 A1, DE 10022544 A1, US 2018/0283799 A1, KR 20130017182 A and KR 101801775 B1 describe installations of this type, developed in various ways in the direction of optimized exploitation of the resources that are the most advantageous in terms of cost and/or environment.

In practice, such installations encounter difficulties that can be chronic or occasional. The risk of temperature drift of the geothermal medium in which the probes are implanted is an essentially chronic difficulty. For example in a temperate or cold region, the geothermal medium suffering excessive demand cools increasingly over the years, to the point of becoming unusable, as the natural regeneration of the ground is insufficient to renew the calories removed. Conversely, in a hot region, the geothermal medium unable to discharge the calories introduced by the air-conditioning system becomes progressively too hot to be usable. In both cases, costly geothermal installations are abandoned after a few years, or otherwise it is necessary to over-dimension them to the point of making them no longer viable for economic reasons. Even if such extremes are avoided, the installation equipped with a geothermal system that has suffered a temperature drift becomes less efficient overall, since the geothermal energy system, which is meant to be one of the most advantageous sources, is no longer as advantageous as was anticipated in the design phase. If the geothermal resource is used cautiously in order to avoid these risks, the resource risks being under-exploited, which is of consequence since this is an installation representing a high investment intended to give access to a form of energy that is both economically and environmentally advantageous.

The aim of the present invention is thus to overcome these drawbacks at least partially, by proposing a method and/or an installation and/or a regulating system capable of durably optimizing the supply of geothermal energy to at least one building or the like.

### DISCLOSURE OF THE INVENTION

According to a first aspect of the invention, the method for controlling an installation associated with an energy-consuming structure, this installation comprising at least one source of geothermal energy with which thermal storage is performed, at least one other source of energy, items of equipment for transforming and distributing energy in the structure, and a regulating system, the geothermal source comprising thermal exchange probes installed in a geothermal medium and adapted to allow heat exchange between the geothermal medium and a heat transfer fluid passing through the probes, is characterized by:
defining a forecast trajectory of the temperature of the geothermal medium over time:
evaluating at least substantially in real time the temperature of the geothermal medium and/or the thermal power exchanged with the geothermal medium;
making an adjustment of the thermal power exchanged between the heat transfer fluid and the geothermal medium in the direction of at least approximate conformity of the temperature of the geothermal medium with the forecast trajectory.

The invention rationalizes the exploitation of the geothermal medium as a natural source of thermal energy and as a thermal reservoir. It makes it possible at the same time to reduce the initial investment for a given energy performance, to improve the efficiency of the probe field as source and of the geothermal medium as reservoir, and to perpetuate the initial performance of the probe field.

Within the meaning of the invention “thermal” is a generic adjective denoting indiscriminately “heating” (or “with heating effect”) and “cooling” (or “with cooling effect”). The “heat transfer fluid” carries “thermal” energy, thus an energy that can equally well have a heating or cooling effect, since the fluid that carries calories naturally tends to cool one environment and heat another therewith.

By “geothermal medium” is meant a portion of ground covering a certain surface area and extending over a certain depth (for example 100 metres or more), in which thermal energy collectors called probes have been placed, located in bores. The probes are passed through by the heat transfer fluid, which carries the thermal energy between the geothermal medium and the installation. By “natural ground” is meant here the ground that surrounds the geothermal medium without being significantly influenced by the temperature thereof. Of course, the boundary between the geothermal medium and the natural ground is theoretical: in concrete terms there is an area of transition between the two.

The heating capacity of a geothermal medium is considerable. This means that a temperature variation of a few tenths of a degree in the geothermal medium corresponds to large amounts of thermal energy. Thus, not only can large amounts of thermal energy be extracted from the geothermal medium, but equally large amounts of thermal energy can also be injected into it for storage purposes. It is possible for example to store heat in summer that will be used the following winter for heating purposes, and to store cold in winter that will be used the following summer for cooling/air-conditioning purposes. The probes used in this way are often called BTES probes (Borehole Thermal Energy Storage).

Before startup of the installation, according to the invention a temperature trajectory is defined for the geothermal medium that typically corresponds to a compromise deemed optimum between various criteria, which can comprise in particular: investment cost, operating cost, environmental aspects, available ground surface area, characteristics of the ground. Some of these criteria involve parameters relating to other items of equipment of the installation. For example, the investment cost to be taken into account is in fact a cost differential with other options for energy capture, production and/or storage.

With the invention, the temperature of the geothermal medium is no longer an erratic consequence of the energy capture and storage processes, but a controlled data item of this operation. Thus, for example, with the invention it is quite possible to store heat in a geothermal medium that is cooler than the natural ground or to store cold in a geothermal medium that is hotter than the natural ground. This is even advantageous, as will be seen below.

The invention makes provision to adjust the thermal power exchanged with the geothermal medium. By “exchanged” is meant “brought into storage” in the geothermal medium and/or “removed” from the geothermal medium. The power is adjusted so that the actual temperature of the geothermal medium conforms as far as possible, at each instant, with the forecast trajectory.

In an installation implementing the invention, this search for conformity is not necessarily continuous. It may concern only certain phases of operation of the installation. In a typical installation, these phases can be described as “normal”. Indeed, the benefit there might be in diverging from the forecast trajectory in certain circumstances, but without losing control of the actual trajectory, will be seen below.

In a simple example, the forecast trajectory can correspond to a uniform, or substantially uniform, value of the temperature. This is the case for example if phases of storage and discharge of thermal energy follow one another sufficiently rapidly so that the temperature of the geothermal medium remains substantially constant. For example, there can be storage during the day and discharge at night, or vice versa.

Other examples are presented below, but with a non-uniform temperature trajectory.

In a version that is simple in its principle, in order to adjust the power exchanged so that the trajectory of the actual temperature of the geothermal medium coincides with the forecast trajectory, the temperature of the geothermal medium is measured and the thermal power exchanged is adapted to continuously bring the actual temperature as close as possible to the temperature prescribed by the trajectory. In practice, this technique is not the most efficient in its implementation. The temperature of the geothermal medium is difficult to measure with accuracy and only changes very slowly. By the time an error in this temperature becomes apparent, the energy involved in correcting the error can be considerable.

For this reason, according to the invention, it is preferable to predefine the power that the heat transfer fluid must exchange with the geothermal medium as a function of time, in other words to define a forecast timing chart of thermal power exchanged, and to measure substantially continuously the power actually exchanged and if need be to correct it for the immediate future or the short term in order to return to conformity with the timing chart in terms of energy exchanged. Monitoring the temperature of the geothermal medium is then no longer used to regulate in a short response time the power exchanged, but to check in the long term the validity of the model on the basis of which the timing chart was established, and if need be to correct this model and, with it, the timing chart, or even the trajectory itself, or also to detect if there is a reason to compensate the cumulative effect of the temporary divergences between the actual temperature of the geothermal medium and the forecast trajectory.

According to the invention, the installation comprises, in addition to the geothermal source, at least one other source. Typically, the implementation of the forecast trajectory lies within overall management of the installation. Within the framework of this overall management, correct management of the geothermal source ranks as a high priority. A first reason for this is that geothermal energy is very advantageous economically. A second reason for this is the necessity, according to the invention, of preserving the thermometric stability of the geothermal source. This prioritization of the management of the geothermal resource on the basis of criteria of which some are extraneous to the level of the demand and the nature of the demand is made possible by the ability to implement the at least one other source in order to supplement the power to match the demand.

In a preferred version, the trajectory has, as an annual mean, a temperature differential with the temperature of the natural ground. Thus the conditions for establishing a thermal flux between the geothermal medium and the natural ground are created. In particular, preferably, over the whole duration for which it is established, the trajectory has a difference in one and the same direction with the temperature of the natural ground. Even more particularly, very preferably, in the case of an installation where, as an annual mean, the geothermal energy supplies the structure with more heating power than cooling power, the trajectory is chosen to be, as an annual mean, below the temperature of the natural ground.

This choice is surprising for an installation using thermal storage, in which the assumption would be to build up a heat reserve by overheating the geothermal medium as much as possible with respect to the natural ground. The invention goes against this assumption: the geothermal medium cooler than the natural ground causes a heat flux from the natural ground to the geothermal medium. Thus, the calories supplied by the installation with a view to storage are increased by those originating from the natural ground. Thus “free” calories, and at the same time the same thermal flywheel effect as if the probe field were larger, are obtained. And there again, contrary to what may be thought, the lower temperature in the geothermal medium only very marginally adversely affects the efficiency of the items of equipment of the installation that use the stored heat. In fact, the heat transfer liquid reaching the probes to remove heat from the geothermal medium is in any case at a much lower temperature than the geothermal medium. If for example these items of equipment are heat pumps, their performance coefficient will be dictated by the two temperature extremes of the heat transfer fluid, and very little by the (intermediate) temperature of the geothermal medium. The temperature differential between the geothermal medium and the natural ground can be a few ºC, for example of the order of 2 to 4° C.

In another version, where, as an annual mean, geothermal energy supplies the structure with more cooling power than heating power, the trajectory is chosen to be, as an annual mean, above the temperature of the natural ground. With this version of the invention, “free” frigories are extracted from the natural ground by the geothermal medium, with economic advantages (reduction in the size of the probe field, increase in the thermal storage) similar to those mentioned above for the storage of heat at a lower temperature than the natural ground. There again, the temperature differential between the geothermal medium and the natural ground can be a few ° C., for example of the order of 2 to 4° C.

In a preferred typical version, in a steady state condition after a transitory period, the forecast trajectory fluctuates over time, either side of a substantially stable mean value. This version is particularly advantageous in the frequent case of an installation where geothermal energy supplies heat in winter and cold in summer. Thus the extraction of heat in winter corresponds to storage of cold for the following summer, and conversely the extraction of cold in summer corresponds to storage of heat for the following winter. In such a case, the temperature of the geothermal medium decreases during a part of the year where heat is extracted and increases during another part of the year where cold is extracted. Generally, geothermal energy is almost always the most advantageous source of thermal energy. It is therefore beneficial to exploit it whenever possible, both for extraction and for storage, without however, according to the invention, causing the temperature of the geothermal medium to drift. On the other hand, it is unusual for the heat requirement and the cold requirement to be equal. In some installations, in particular some installations in temperate regions, the heat requirement in the cold or cool season is greater than the cooling requirement in the hot season. It is then possible, according to the invention, to extract the maximum possible cold, and only extract the corresponding amount of heat, in order to comply with the stability of the trajectory. Having given the trajectory a mean temperature below the temperature of the natural ground, it will however be possible to extract more heat than cold, according to the requirement in this example, while still ensuring the thermal stability of the geothermal medium.

Generally, in an embodiment of the method, the trajectory is defined for successive instants in the direction of an overall optimization for each instant in question and its future. In other words, according to the invention, for example extracting during winter amounts of heat so large that the storage for the following summer risks being insufficient to ensure the thermal stability of the geothermal medium is avoided. To this end, in certain preferred versions of the method, the invention proposes predicting the thermal requirements of the building over a complete season (1 year).

In a version of the invention, the power of the installation apart from geothermal energy is sufficient to satisfy the needs of the users. However, geothermal energy is almost always the most advantageous source. Its use is prioritized with respect to the other sources. The invention can then consist of controlling the power supplied by the geothermal energy so that the temperature trajectory of the geothermal medium is complied with. An automation manages the rest of the installation so as to satisfy the demand from the at least one other source. This version is advantageous due to its relative simplicity of regulation and its capacity for strict compliance with the temperature trajectory forecast for the geothermal medium.

However, this version requires the power of the installation to be over-dimensioned and it does not optimize the application of the geothermal resource. For one and the same mean annual power supplied by geothermal energy, it is beneficial to give greater weight to geothermal energy in the periods when the other sources are particularly disadvantageous in terms of cost, environmental reasons, etc. Moreover, the possibility of giving greater weight to geothermal energy in a period of high demand for power makes it possible to reduce the installed power of the other sources. For this reason, as already mentioned above, the method according to the invention can advantageously, at an instant of intervention, allow the temperature of the geothermal medium to diverge from the forecast trajectory for the time following the intervention.

Thus, at certain instants after startup of the installation, the method can command or allow a deviation with respect to the forecast trajectory in cases where values of at least one parameter diverge from the estimate thereof taken into account for defining the forecast trajectory in force up to the moment of the intervention.

In the aforementioned example of an installation that must supply more heat than cold, it is possible for example to extract more cold than forecast according to the forecast trajectory in the case of a particularly hot summer or more generally of actual demand greater than that which had been forecast during the establishment of the forecast trajectory. Thus the additional requirement for cold is advantageously regulated and at the same time the means for an additional extraction of heat during the cold season are obtained, by at least partial replacement with another, less advantageous, heat source of the installation.

In other cases, the values that diverge from the estimate thereof can be or comprise forecast values relating to instants subsequent to the instant of intervention. For example, it is possible to reduce the power exchanged with the geothermal source at an instant of intervention, even if this corresponds at this instant to a deterioration in efficiency, with the prospect of a future change in a parameter taken into account for defining the forecast trajectory. This change can be for example the expected consequence of a predicted exceptional meteorological phenomenon. Conversely, in certain cases of a predicted event, the application of geothermal energy can be intensified. For example, with the prospect of a period of heatwave, a decision can be made to build up a cold reserve in advance by freezing the contents of a cold accumulation tank by virtue of a heat pump extracting cold from the geothermal medium in order to inject it into the tank.

In certain situations, energy that is free or very low cost is available, for example if photovoltaic solar panel collectors of the installation produce more electricity than demanded by the items of user equipment. The excess electricity can feed a heat pump injecting thermal energy into the geothermal medium, in the form of calories or frigories as a function of the direction of a current divergence between the actual temperature of the geothermal medium and the forecast trajectory, or also, conversely, to form or increase such a divergence in a favourable direction as a function of the season in progress or in anticipation of the next season, or even to contribute to a correction of a drift of the mean temperature of the geothermal medium.

Several versions of the method allow the trajectory of the actual temperature of

the geothermal medium to diverge from the forecast trajectory, in particular in the circumstances that have just been described.

In a first version, the method preferably comprises:
initiating an episode of deviation during which the trajectory diverges temporarily from the forecast trajectory in order to take into account exceptional situations relating to at least one of the parameters, or a combination of several of the parameters,
defining at the start of the episode the thermal power exchanged in the at least one probe so that the temperature of the geothermal medium diverges from the forecast trajectory, and
defining for the temperature of the geothermal medium a deviation trajectory temporarily divergent from the forecast trajectory.

In this version of the invention, at an instant of intervention in which it is decided to make the temperature of the geothermal medium diverge with respect to the forecast trajectory, a deviation trajectory is established that will make it possible to retain control of the temperature of the geothermal medium even during the time when it has diverged from the forecast trajectory.

Preferably, the deviation trajectory comprises a divergent phase throughout which the deviation trajectory diverges from the forecast trajectory, and a catchup phase that aligns the divergent phase with the forecast trajectory.

In a second version, the method allowing the actual temperature of the geothermal medium to diverge from the forecast trajectory without losing control of the thermal stability of the geothermal medium in the medium to long term comprises:
controlling the thermal power exchanged as a function of parameters comprising the actual demand, with a degree of freedom with respect to the forecast trajectory: and preferably, to this end:
acquiring a forecast timing chart of the thermal power exchanged with the geothermal medium;
monitoring the at least approximate conformity of the evaluated mean temperature of the geothermal medium with a mean of the forecast trajectory;

in case of drift of the mean evaluated temperature, amending at least indirectly the thermal power exchanged with the geothermal medium, with respect to the forecast timing chart, in a direction tending towards the return to conformity with one out of the mean temperature and the forecast trajectory.

As an example of the establishment of the aforementioned degree of freedom, said logic controls the items of equipment as a percentage of total power, so that in the case of different total power the power of each item of equipment is amended proportionally. In such a case deviation of the actual temperature of the geothermal medium with respect to the forecast trajectory takes place. A measure for correcting the actual trajectory is not always necessary: the inertia of the geothermal medium is so great that an individual deviation has no immediate consequences, and the deviations can compensate one another statistically in the medium term. Thus it is sufficient to monitor compliance with the mean temperature of the geothermal medium over the long term and in the case of drift to amend the parameters of said logic. In the preceding example this would amount to provisionally amending at least some of said percentages. But it is also possible, after a deviation, in particular if it exceeds a certain threshold, to take immediate corrective measures aimed at returning the temperature of the geothermal medium to the forecast trajectory as quickly as possible.

This second version of the method has the advantage of being simple and flexible. It combines in one and the same regulating process divergences allowed by the degree of freedom and divergences deliberately initiated as a function of short-term forecasts, or of opportunities to inject inexpensive thermal energy into the geothermal medium, or also to correct the mean temperature of the geothermal medium.

Independently of the deviation episodes, the method can comprise a process for definitive amendment of the forecast trajectory, the method then comprising, preferably:
updating at least one of the estimates according to a long trend observed or anticipated for at least one of the parameters, different from the preceding estimate taken into account for defining the forecast trajectory in force:
definitively replacing the forecast trajectory with a new forecast trajectory taking into account the at least one updated estimate.

The updated estimate can be the result of an observation that reality has contradicted the preceding estimate, or also a development of certain parameters over the course of time. For example, the intended use of a building may have been changed, new items of equipment may have been installed therein, an item of equipment may be out of service, etc.

In an advantageous version, as a function of parameters relating to the climate, to the sources and to the energy requirements of the installation, the regulating system commands a selective activation of the sources and of the items of equipment of the installation, as well as selective connections between sources and items of equipment, and carries out power regulation of the items of equipment, in the direction of satisfying the requirements and of an optimization with respect to at least one criterion, said power regulation comprising said adjustment of the thermal power exchanged between the heat transfer fluid and the geothermal medium in the at least one probe. The at least one criterion can be economic, environmental, comfort-related, maintenance-related, etc.

In a particularly preferred version, the regulating system defines a succession over time of combinations of activation states of at least some of the items of equipment and of the sources over a duration subsequent to the current instant, in a direction of an optimization including the future, with respect to the at least one criterion.

Even more preferably, the method comprises taking into account forecasts for at least one parameter chosen from: at least one price for energy originating from a source, and at least one climatic parameter out of the exterior temperature, sunshine and wind speed.

The designers of a complex of buildings usually establish what is called in France a “Dynamic Thermal Modelling” (DTM) for the building, which is a forecast of the thermal energy requirements of the building in its different forms (heating, cooling/air-conditioning, sanitary hot water, etc.) in a very detailed manner over time, as a function of a mean meteorology of the region, the exposure of the building to sun, wind or other, the intended use, etc. Starting from this, according to the invention a catalogue of items of equipment is acquired and all the possible combinations that correspond to this demand with a sufficient safety coefficient are systematically explored, each of them is evaluated with respect to certain criteria, which can comprise the cost of investment, the annual operating cost, the environmental impact, etc. Within this framework, each of these combinations is the subject of a forecast trajectory for the temperature of the geothermal medium. For one and the same combination of items of equipment, several trajectories can be tested. The combination having the balance that is considered to be the best is retained, with its forecast trajectory regarded as the best. The chosen configuration is the subject of a scenario forecasting, at relatively high frequency, typically every quarter of an hour, the states of activation and connection of the different items of equipment of the combination over an entire year. The forecast trajectory and the adjustment of the power exchanged with the geothermal medium form part of this scenario. In service, the scenario is implemented while still being renewed for the coming year on a rolling basis. Preferably, the scenario is a set of recommendations supplied by a control unit to an automatic control system that manages the satisfaction of the actual needs by activating the items of equipment with priority rankings that are a function of these recommendations. Of course, it is necessary to avoid recommendations that are too strict preventing the satisfaction of needs that the items of equipment of the installation would have been able to satisfy. Thus there is established, between the control unit controlling the method in the direction of compliance with the forecast trajectory and the automatic control system that controls the activation states of the items of equipment in the installation, the degree of freedom discussed above concerning certain episodes of deviation of the actual temperature of the geothermal medium with respect to the forecast trajectory. This degree of freedom does not rule out that the control unit itself initiates deviations, in particular to anticipate future events (heatwave, cold spell, etc.) or to exploit opportunities to inject inexpensive thermal energy into the geothermal medium, or also to correct a drift of the mean temperature of the geothermal medium.

In a preferred version, before commissioning of the installation, tests of the thermal response of the geothermal medium to thermal exchanges are conducted by means of a test probe, so as to determine the thermal conductivity and the heating capacity of the geothermal medium. These tests make it possible to forecast the thermometric evolution of the geothermal medium as a function of the thermal power exchanged therewith.

Advantageously, in service, the temperature of the heat transfer fluid at the inlet and at the outlet of the probes and the flow rate of the heat transfer fluid are measured, the flow rate and the difference between these two temperatures are used to calculate the thermal power exchanged with the geothermal medium, and the corresponding variation in the temperature of the geothermal medium is determined using a prior modelling of the geothermal medium. This modelling can be carried out by experiment and/or preferably according to the results of the aforementioned tests. The temperature of the geothermal medium is thus evaluated by calculation rather than by measurement. As stated above, direct measurement is difficult, except to verify over the long term the absence of significant drift, and in the case of drift to correct the exchanged power timing chart for the future.

Within the framework of the geothermal storage, the method comprises regeneration phases during which thermal energy, hot or cold, supplied by the installation from another source connected to the installation is injected into the geothermal medium by means of the heat transfer fluid and the at least one probe. For example, depending on the climatic conditions, an item of aerothermal energy equipment can supply free thermal energy which, in particular if it has no other use in the installation, be collected and transferred to the geothermal medium. As another example, if the installation comprises photovoltaic panels, a surplus of photovoltaic electricity can feed an aerothermal heat pump transferring thermal energy from the atmosphere to the geothermal medium.

In another installation or the same one, the method can comprise, as part of the geothermal storage, regeneration phases during which heat known as “unavoidable” heat, supplied by an item of equipment of the installation fed by one said other source, is injected into the geothermal medium by means of the heat transfer fluid and the at least one probe. The residual heat of a process that does not have the main object of producing this heat is called unavoidable heat. This is the case in particular for the heat expelled by an air-conditioning unit or, more generally, a refrigeration appliance. By using the geothermal medium as heat source of the appliance, the geothermal medium is thermally regenerated as a future heat source at the same time as the appliance is permitted to carry out its main function of cooling.

According to another aspect of the invention, the installation for supplying thermal energy to a consuming structure, the installation comprising:
items of equipment for collecting energy that are in an energy exchange relationship with respective sources, these items of equipment comprising at least one geothermal probe in a thermal exchange relationship with a geothermal medium;
items of equipment for transforming energy, at least partially fed by the items of collection equipment;
items of equipment that are users of energy, supplying energy to the structure;
a regulating system capable of defining, for at least some of the different items of equipment, respective activation states chosen as a function of parameters, in particular climatic parameters, in the direction of an optimization with respect to at least one criterion;
is characterized in that the regulating system implements a method according to the first aspect, complemented if necessary by all or some of its improvements.

According to a third aspect of the invention, the system for regulating an installation for supplying thermal energy to a consuming structure, the installation comprising:
items of equipment for collecting energy that are in an energy exchange relationship with respective sources, these items of equipment comprising at least one geothermal probe in a thermal exchange relationship with a geothermal medium:
items of equipment for transforming energy, at least partially fed by the items of collection equipment:
items of equipment that are users of energy, supplying energy to the structure:
the regulating system being capable of defining, for at least some of the items of equipment, different respective activation states chosen as a function of parameters, in particular climatic parameters, in the direction of an optimization with respect to at least one criterion:
is characterized in that the regulating system implements a method according to the first aspect, complemented if necessary by all or some of its improvements, or is integrated in an installation according to the second aspect.

Preferably, the regulating system of the second or of the third aspect comprises at least one input capable of receiving forecasts concerning a period subsequent to the current instant. These can be in particular meteorological forecasts supplied in software-exploitable form, and which can thus be taken into account for updating the forecast or actual trajectory of the temperature of the geothermal medium, or in the case of the implementation of a scenario as disclosed above, for updating the scenario in an anticipatory manner.

Other features and advantages of the invention will become more clearly apparent from the following description, with reference to non-limitative examples.

### BRIEF DESCRIPTION OF THE FIGURES

In the attached drawings:

FIG. 1 is a diagrammatic representation of an installation according to the invention, in a building:

FIG. 2 is a temperature diagram over a year, showing the forecast trajectory of the temperature of the geothermal medium and the timing chart of the thermal power exchanged in the probes:

FIG. 3 illustrates a deviation episode by means of a very schematic diagram of temperature as a function of time, with scale distortion for the purposes of visibility: and

FIG. 4 is a diagram in three parts of temperature as a function of time, corresponding to three successive sections of a year, with successive deviation episodes.

The following description is understood as describing any feature or combination of features, in the terms used hereinafter or in more general terms, provided that this feature or combination of features produces a technical effect or advantage, even if the feature or combination of features constitutes only a part of a sentence or of a paragraph.

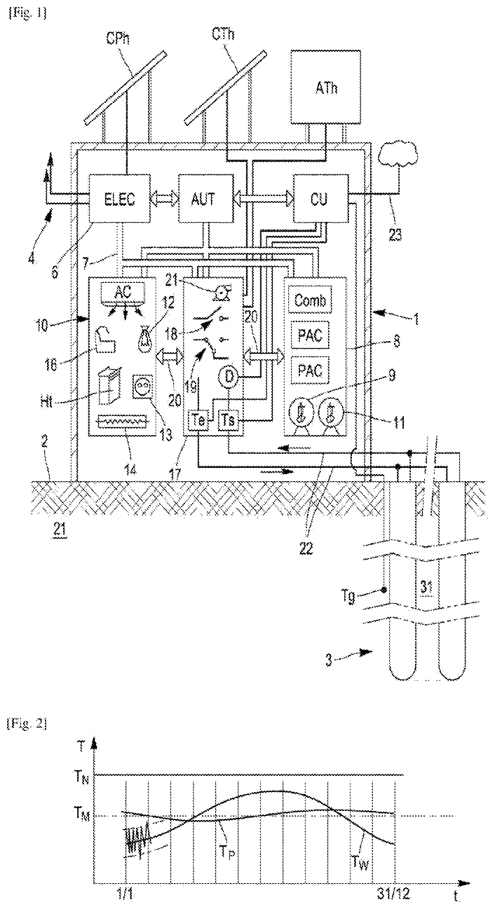

In the example shown in FIG. 1, the installation is associated with a building 1 sited on a plot 2. The installation comprises items of equipment for collecting energy, here comprising at least one photovoltaic solar panel collector CPh, at least one thermal solar collector CTh transforming the solar radiation into heat absorbed by a heat transfer liquid passing through the collector, at least one aerothermal exchanger ATh capable of operating as a thermal collector or as a thermal dissipator for a heat transfer liquid passing through said collector, by exchange of calories between the liquid and the exterior air, several geothermal probes 3 and at least one connection to a public electricity distribution network 4. The geothermal probes 3 are of the BTES type sunk in an area of the plot 2 and of the corresponding subsoil, which will be called here geothermal medium 31 to distinguish it from the natural ground 21 which is not influenced thermally by the probes 3. There may also be a fuel tank or a connection to a distribution network for fuel, in particular for gas (not shown). In other embodiments, certain types of collection equipment such as CPh, CTh and/or ATh are not present, the invention being capable of implementation provided that the geothermal energy is not the only thermal source available for producing heat or cold.

An electrical cabinet 6 receives the electrical energy from the network 4 and from the photovoltaic solar panel collector CPh and supplies electricity from one and/or the other of these origins via a power outlet 7. In certain embodiments the cabinet 6 can also inject electricity produced by the photovoltaic solar panel collector CPh into the public network 4.

Moreover, the installation comprises an assembly 8 of items of equipment for transforming and storing thermal energy, namely, in the example, heat pumps PAC, a boiler Comb for exceptional periods, as well as a cold tank 9 and a hot tank 11 that typically contain water with additive. The fleet of heat pumps PAC makes it possible to produce cold and heat at will. The cold tank 9 is intended to accumulate cold by freezing all or part of the water that it contains, and to return this cold by total or partial thawing of its frozen content. Each tank 9, 11 contains a heat exchanger for exchanging heat with a heat transfer fluid in order to receive or supply thermal energy in association with the sources, via an interposed heat pump or not.

Also in the installation there is an assembly 10 of items of user equipment that are interfaced with the user for the energy consumption thereof, namely for example lights 12 and electrical sockets 13, air-conditioning modules AC, heating modules Ht, underfloor heating 14, sanitary hot water distribution points 16 (only a single one of each is shown for the sake of clarity).

The installation also comprises a selective connection assembly 17, capable of establishing appropriate connections between the thermal collectors 3, ATh, CTh, the items of storage and transformation equipment 8 and the items of user equipment 10. The connection assembly 17 typically comprises pipes, one-way solenoid valves 18, multi-way solenoid valves 19, and pumps 21. The assembly 17 is connected to the probes 3 by conduits 22 for a heat transfer liquid, generally water with additive, flowing in the probes 3 where this heat transfer liquid exchanges heat with the geothermal medium 31.

In the installation there are also multiple temperature, pressure and flow rate sensors, as well as electricity sensors such as ammeters, and multiple control appliances such as thermostats or switches, some available to users, others available to technical or building management staff. In this respect only a temperature sensor Te for the heat transfer liquid entering the probes 3, a temperature sensor Ts for the heat transfer liquid leaving the probes 3, and a flow meter D measuring the flow rate of heat transfer liquid in the probes 3, as well as, optionally, a sensor Tg for the temperature of the geothermal medium 31 have been shown. It is known that beyond a certain depth where it is no longer influenced by the surface temperature, the temperature of the geothermal medium increases with the depth (geothermal gradient). The probe Tg is placed at a depth chosen so that the local temperature there is representative of a mean for the geothermal medium 31.

The representation of the assemblies 8, 10 and 17 in the form of blocks in FIG. 1 is conceptual: in practice the different items of equipment of each of these assemblies can be distributed within the building. This is in particular, but not only, the case for the items of user equipment 10. The double horizontal arrows 20 between these blocks symbolize the fluidic connections between them.

The installation can be configured in numerous ways by a programmable automatic control system AUT that selectively connects together the different items of equipment as a function of parameters comprising in particular the level of the demand for each form of energy (electricity, heating, cooling, sanitary hot water, etc.) and the power available originating from the items of local collection equipment (CPh, CTh, ATh, 3). Generally, multiple combinations of activation states of the different items of equipment are capable of satisfying the demand. A control unit CU executes an optimization program that outputs recommendations sent to the automatic control system AUT to allow the automatic control system AUT to select and activate the optimum combination of the activation states. The recommendations are orders of priority among items of equipment having similar functions, or also advice for activation levels of the items of equipment, or also recommendations relating to the modes of operation for the items of equipment having at least two modes of operation, such as for example the items of equipment capable of participating in the production of cold or heat (heat pumps PAC if they are reversible), the items of equipment that can donate or acquire energy (tanks 9, 11), the collectors such as the probes 3 or the aerothermal collector ATh that can function as collector of cold or of heat, the air-conditioning modules AC if necessary capable of operating for heating or for cooling. The automatic control system and the control unit could be grouped together in a single “smart” automatic control system. The subdivision proposed here is advantageous as it is compatible with a pre-existing installation, equipped with a conventional automatic control system AUT, which has been retro-fitted according to the invention by adding to it in particular the control unit CU and optionally some of the items of collection 3, CPh, CTh, ATh, transformation and storage 8, user 10 and connection 17 equipment.

The electrical unit 6 is connected to the automatic control system AUT which controls it. The power outlet 7 feeds electricity to the three assemblies 8, 10 and 17, as well as (not shown) the automatic control system AUT and the control unit CU.

The possible configurations in service are multiple. Certain preferred configurations involve the geothermal medium 31 via the probes 3. For example:
The geothermal medium 31 is the cold source of at least one heat pump PAC supplying heat to the underfloor heating 14 or to the reversible air-conditioning module AC, with electrical energy supplied by the network 4 and/or by the photovoltaic solar panel collectors CPh.
The geothermal medium 31 is the cold source of at least one heat pump PAC supplying heat to the hot tank 11, with surplus electrical energy supplied by the photovoltaic solar panel collectors CPh.
The geothermal medium 31 is the heat source of at least one heat pump PAC supplying cold to the reversible air-conditioning module AC, with electrical energy supplied by the network 4 and/or by the photovoltaic solar panel collectors CPh.
The geothermal medium 31 is the heat source of at least one heat pump PAC supplying cold to the cold tank 9, with surplus electrical energy supplied by the photovoltaic solar panel collectors CPh.
The geothermal medium 31 is heated with heat supplied by the thermal solar collector CTh or the aerothermal collector ATh, by means of a heat pump PAC or directly.
The geothermal medium 31 is cooled by evacuation of heat to the atmosphere by the aerothermal collector ATh, by means of a heat pump PAC or directly.

Of course, other configurations not described here, in particular not involving the geothermal medium, are made possible by the installation, for example the production of heat by heat pumps PAC using as cold source the aerothermal collector ATh, or by the thermal solar collector CTh by means of heat pump PAC or not, the production of cold by heat pump PAC using as heat source the thermal solar CTh or aerothermal ATh collectors, additional heating by the combustion boiler Comb or by Joule effect, etc, etc. Many configurations can coexist, for example additional heating by combustion or Joule effect while the geothermal medium suffering excessive demand is in the process of being recharged with heat by one of the configurations indicated above.

According to the invention, the implementation of the geothermal probes is controlled over quite a long timescale, typically annually, so as to avoid temperature drift of the geothermal medium over the years.

To this end, as shown in FIG. 2, according to the invention a forecast trajectory TP of the temperature of the geothermal medium over the course of a year is established. The graph in FIG. 2 is graduated on the x-axis from 1/1 (1^{st} January) to 31/12 (31 December). In this example, seasonal thermal storage is performed, consisting of the cooling of the geothermal medium due to withdrawal of heat during the cold season constituting at the same time storage of cold with a view to the hot season that will follow. Conversely, withdrawal of cold during the hot season heats the geothermal medium and at the same time constitutes storage of heat for the cold season that will follow. For this reason, in the example shown (typical of the temperate zone of the Northern Hemisphere in terms of calendar and variations), the forecast temperature TP drops at the start of the year during the cold season, then increases up to a maximum during the hot season before starting to drop again at the start of the following cold season.

Despite these fluctuations, the temperature according to the forecast trajectory TP is stable as a multi-year mean TM. To this end, the thermal power exchanged through the probes 3 is adjusted in real time so that the actual temperature of the geothermal medium generally conforms to the forecast trajectory TP. For this adjustment, it could be envisaged to regulate the power exchanged according to the temperature of the geothermal medium as measured by the probe Tg. But this method, the principle of which is simple in itself, encounters practical difficulties because measurement by the probe Tg is insufficiently accurate for the small deviations to be detected. For this reason, it is preferred to use as a basis a modelling of the geothermal medium, consisting of a value for its heating capacity and a value for its thermal conductivity. For these two parameters it is possible to adopt either approximately known values from experience or values determined by prior tests conducted by means of a test probe (not shown). During these tests thermal exchanges are carried out with the natural ground via the test probe and the effects thereof are measured. As these two parameters are known, it is known that the total energy exchanged in one and the same direction (for example heat withdrawal) over a certain period is equal to the variation of the thermal content of the environment 31 over this period, increased by the thermal contribution (as an algebraic value) of the natural ground 21 over said period. Said thermal contribution can be forecast according to the thermal conductivity. The probe Tg serves to verify the stability of the temperature of the geothermal medium over the long term, and therefore to validate the model or, in the case of drift, to trigger corrective recommendations and/or a revision of the model.

The diagram in FIG. 2 also shows the curve TW of the temperature of the heat transfer liquid leaving the probes. The left-hand part of FIG. 2 shows the actual value with very rapid variations, as measured by the probe Ts in FIG. 1. These variations are due for example to the startup of a heat pump at certain times of day and not at others. The curve denoted by the reference TW corresponds to a smoothing of the actual temperature. When TW<TP, the heat transfer fluid withdraws heat from the geothermal medium 31, which therefore makes its temperature TP drop. Conversely, when TW>TP, the heat transfer fluid injects heat into (withdraws cold from) the geothermal medium 31, which makes its temperature TP rise.

The trajectory TP is stable over the long term when the difference between the total energy withdrawn in the form of heat (in the cold season) and the total energy injected in the form of heat (in the hot season) is equal to the energy supplied over the same period by the natural ground 21 to the geothermal medium 31.

The energy exchanged is the integral of the thermal power exchanged with respect to time. The power exchanged is proportional to the flow rate of the heat transfer fluid, measured by the sensor D, multiplied by the difference between its inlet temperature and its outlet temperature, as measured by the sensors Te and Ts respectively. The sensors D, Te and Ts thus make it possible for the control unit CU to calculate the power exchanged then, by an integration in time, the energy exchanged.

As a function of parameters associated with the building, its location, its equipment and its intended use, it is determined if it is of benefit to withdraw more cold or more heat from the geothermal medium, as a function of criteria that may be economic, environmental, associated with comfort or ease of maintenance, or etc. According to a significant feature of the invention, it is ensured that the thermal flux between the natural ground 21 and the geothermal medium 31 is oriented in the same direction as the thermal flux that is chosen to be favoured. In the example shown in FIG. 2, which typically corresponds to that of a residential building in a temperate zone, it is desired to favour withdrawal of heat. In other words, it is desired to withdraw more heat than cold from the geothermal medium 31. To this end, the trajectory TP has been chosen so that its mean multi-year temperature TM is below the temperature TN of the natural ground 21. Thus, the total energy that can be withdrawn in the form of heat is equal to the sum of the energy injected in the form of heat by the probes 3 during the hot season and the energy provided by the permanent flux between the natural ground 21 and the geothermal medium 31.

Generally, there is an imbalance between the heating energy and the cooling energy that would be likely to be withdrawn from the geothermal medium 31, which would result in a drift of the multi-year mean TM. In order to define a forecast trajectory TP that avoids this pitfall without applying an excessive temperature differential between TM and TN (a differential that would eventually harm the collection efficiency), the invention proposes for example to adopt as a basis a maximum withdrawal of that of the two energies which has the lowest required amount (in the example in FIG. 2, cold), and to limit the withdrawal of the other form of energy so that the energy balance of the whole is in equilibrium, characterized by stability of the multi-year mean TM.

Specifically, in the installation in FIG. 1, the automatic control system AUT controls the instantaneous activation states of the items of equipment, in particular those cooperating with the probes 3, as a function of the demand originating from the users, from the technical staff or from certain automatic devices such as thermostats or time switches. This instantaneous control gives rise to very rapid variations in the temperature TW that are illustrated in the left-hand part of FIG. 2. However, by virtue of the sensors D, Te, Ts, the control unit CU evaluates the thermal power exchanged and monitors to what extent the latter corresponds to compliance with the forecast trajectory TP of the temperature of the geothermal medium.

Typically, the control unit CU calculates the energy balance (difference between the heating energy and the cooling energy) of the exchanges with the geothermal medium and determines if this balance satisfies the compliance with the mean temperature TM. In the case of drift, the control unit CU corrects its usual recommendations and/or issues corrective recommendations.

If the measurements by the probe Tg or a drift of the difference between the inlet and outlet temperatures of the water for a given flow rate suggest that the mean temperature of the geothermal medium is drifting while the energy balance of the exchanges is normal, a procedure for revising the model can be initiated.

Up to this point, the geothermal storage has been described as fed by the unavoidable energy from processes having another main use. For example, the storage of cold results from the withdrawal of heat, and the storage of heat results from the withdrawal of cold. The invention is not limited thereto: it also envisages episodes of regeneration of the geothermal medium during which an item of equipment is activated with the sole purpose, or the main purpose, of injecting thermal energy into the geothermal medium 31. For example, in the case of surplus electricity available from the photovoltaic solar panel collector CPh, this electricity can feed a heat pump PAC that injects heat or cold into the geothermal medium 31. In the case of surplus thermal energy available from one and/or the other of the collectors CTh and ATh, said energy can be conveyed into the geothermal medium.

In a preferred version of the invention, the forecast trajectory of the temperature TP of the geothermal medium forms part of a forecast scenario of the operation of the installation, typically over a year. The scenario is based on the one hand on the DTM (Dynamic Thermal Modelling) of the building, which anticipates consumption at each instant as a function of different parameters relating to the building, its location and its intended use, and on the other hand on the items of equipment of the building as regards thermal energy. The scenario forecasts at a very rapid cadence, typically every quarter of an hour, the optimum combination of the activation states that will satisfy the requirements of the building. This optimization should not be understood for the instant in question, but also taking into account the future. For example it will be possible to dispense with application of the geothermal medium, even if this would be the most advantageous at the instant in question, if it is preferred to save this energy for a future use that is even more advantageous. The forecast trajectory TP of the temperature of the geothermal medium fits within this logic since, as seen above, use of the geothermal heat beyond what it would later be possible to inject as cold is for example dispensed with, so as to remain in conformity with the trajectory and with the mean temperature TM.

In an even more preferred version, the design of the installation passes through a step of optimization of the full complement of equipment. To this end, a catalogue of items of equipment is used as a starting point, the combinations that are capable of satisfying the DTM with a sufficient, but not excessive, safety coefficient are sought by systematic computer-assisted analysis, for each one of these the most advantageous scenario is sought as a function of criteria (economic, environmental, etc.), then the installation is chosen that offers the compromise deemed the most favourable between a scenario that is advantageous with respect to the criteria and an installation that is itself advantageous with respect to criteria (investment cost, service life of the items of equipment, footprint, etc.). The installation having been thus defined with its scenario, said scenario prescribes in particular the thermal power exchanged, every quarter of an hour, in the probes. In service, the scenario is extended in rolling fashion so that the forecast always covers a complete year starting from the current instant.

At each instant, the values of the parameters can differ from those on which the scenario and in particular the forecast trajectory TP are established. This can relate equally well to the current values as to the forecast values. For example, the atmospheric temperature can be very different from that forecast in the scenario for the current instant, or also the meteorological forecasts predict an atypical period, for example a cold spell or conversely a heatwave. Events such as an epidemic can considerably affect the occupation of residential or business sites. Thus, in the days preceding a given instant, it may prove to be the case that the scenario is no longer optimum. The same can be true if the values relating to the recent past period have differed from those taken into account for the scenario. If for example a winter has been particularly mild, the geothermal medium has been cooled less than forecast and it is probably possible to withdraw more heat than forecast at the end of the cold season without too great a risk of inability to consume this cold in the hot season. Finally, the user demand will generally, at each instant, be different from that anticipated by the scenario.

In order to be able to take meteorological forecasts into account automatically, the control unit CU has a link 23 (FIG. 1), for example via the Internet, for receiving computerized meteorological information, which is taken into account for these updates.

A preferred version of the invention thus provides that the forecast trajectory TP is only a sort of reference from which the actual temperature of the geothermal medium can diverge as a function of the most recent data relating to the current or future values of the parameters taken into account.

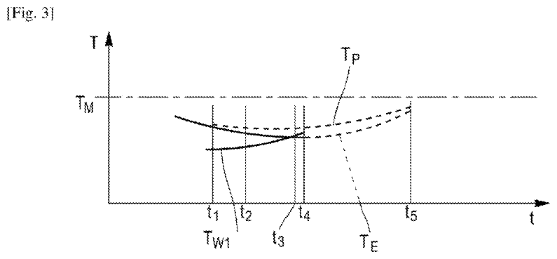

When circumstantial variations affect the parameters (with respect to the scenario), thus in principle temporary, the temperature of the geothermal medium initiates an episode of deviation illustrated very diagrammatically in FIG. 3, where the scales are distorted. For a certain period, a deviation trajectory TE replaces the trajectory TP, which remains but is no longer applied. The deviation trajectory TE diverges temporarily from the trajectory TP and rejoins the trajectory TP after a certain time. In FIG. 3, the deviation trajectory TE started at the instant t1, the instant t2 is that where the temperature curve of the water should have crossed the trajectory TP, but in fact the actual curve TWI crosses the deviation trajectory TE later, at t3. Up to the instant t4, which in this representation is the current instant, the deviation trajectory TE is divergent with respect to the trajectory TP, then from the instant t4 the trajectory TE is oriented to progressively catch up with the trajectory TP at the future instant t5.

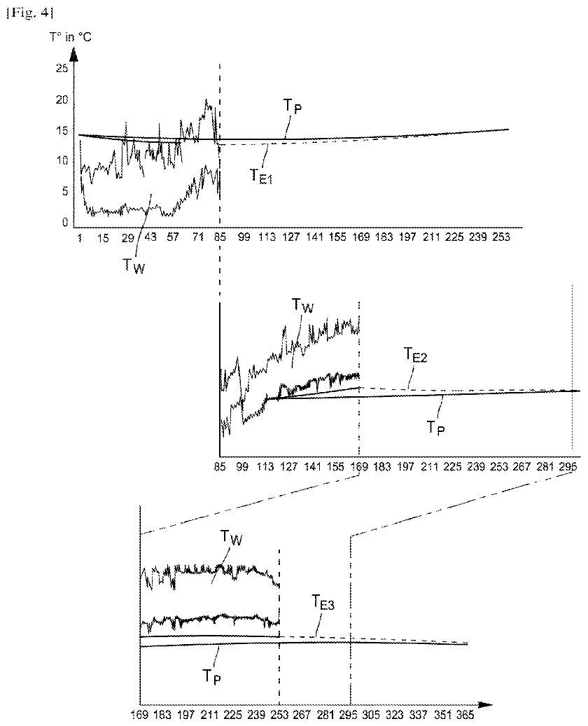

In practice, the reality rarely bears out the detailed forecasts of the scenario and the deviation episodes can become telescoped. An example is given in FIG. 4 showing three successive sections of one and the same year, shown separately in order to make it possible to show more clearly, for each section, what was the deviation trajectory forecast for the future of the deviation.

In the first section, which runs from day I to the current day 85, an exceptionally cold period in spring caused the geothermal medium to cool more than forecast. A deviation trajectory TE1 was followed, forecast to terminate at day 239. But then the spring was very hot and well before the end of the first deviation a second deviation trajectory TE2 intervened as shown in the diagram in the middle of FIG. 4 that runs from day 85 to the current day 169. It forecasts quite a rapid catchup with the trajectory TP at day 295, in order to keep reserves of cold for the rest of the hot season. But finally, with a cold winter forecast (diagram at the foot of FIG. 4, from day 169 to the current day 253) the deviation episode TE2 gave way, before being completed, to an episode according to the deviation trajectory TE3 which extends above the forecast trajectory TP to beyond day 365.

These deviation episodes can be managed by the control unit CU according to one or other of the two versions of the method, disclosed above, namely either by a precise definition of each episode from the control unit CU or preferably under medium to long term monitoring of compliance with the mean temperature TM. Even in this second version, the control unit CU can however influence a deviation episode, and for example launch corrective recommendations if it anticipates a detrimental consequence of the deviation, or conversely reinforcing recommendations if it anticipates favourable consequences.

The control unit CU, in a manner that is not illustrated, can also definitively amend the temperature trajectory TP in different cases: a finding that the actual energy consumption of the building differs from that taken into account for the trajectory in force, modification of the items of equipment, conversion of the building, significant temperature drift of the geothermal medium, etc.

Of course, the invention is not limited to the examples described and represented. Instead of monitoring the temperature stability of the geothermal medium 31 by a probe such as Tg, this can be done by analyzing the temperature variation of the heat transfer liquid having passed through the probes. For example, if cold liquid is injected and heats up less than expected, it can be deduced therefrom that the geothermal medium 31 has cooled.

1. A method for controlling an installation associated with an energy-consuming structure, the installation comprising at least one source of geothermal energy with which thermal storage is carried out, at least one other source of energy (4, CPh, CTh, ATh), items of equipment for transforming and distributing energy in the structure, and a regulating system (AUT, CU), the geothermal source comprising thermal exchange probes installed in a geothermal medium and adapted to allow heat exchange between the geothermal medium and a heat transfer fluid passing through the probes, the method comprising:
defining a forecast trajectory (TP) of the temperature of the geothermal medium over time;
evaluating at least substantially in real time the temperature of the geothermal medium and/or the thermal power exchanged with the geothermal medium; and
making an adjustment of the thermal power exchanged between the heat transfer fluid and the geothermal medium in the direction of at least approximate conformity of the temperature of the geothermal medium with the forecast trajectory (TP).

2. The method according to claim 1, characterized in that the forecast trajectory (TP) has, as an annual mean (TM), a temperature differential with the temperature (TN) of the natural ground.

3. The method according to claim 1, characterized in that the trajectory (TP) has, over the whole duration for which it is established, a difference in one and the same direction with the temperature (TN) of the natural ground.

4. The method according to claim 1, characterized in that, in the case of an installation where, as an annual mean, geothermal energy supplies the structure with more heating power than cooling power, the trajectory is chosen to be, as an annual mean (TM), below the temperature (TN) of the natural ground.

5. The method according to claim 1, characterized in that, in the case of an installation where, as an annual mean, geothermal energy supplies the structure with more cooling power than heating power, the trajectory is chosen to be, as an annual mean (TM), above the temperature (TN) of the natural ground.

6. The method according to claim 1, characterized in that, in a steady state condition after a transitory period, the forecast trajectory (TP) fluctuates over time, either side of a substantially stable mean value (TM).

7. The method according to claim 1, characterized in that the forecast trajectory (TP) is defined for successive instants in the direction of an overall optimization for each instant in question and its future.

8. The method according to claim 1, characterized in that at an instant of intervention the forecast trajectory (TP) can be amended for the time following the intervention.

9. The method according to claim 1, characterized in that at an instant of intervention of the regulation after startup of the installation, the method comprises:
amending the trajectory in cases where values of at least one parameter diverge from the estimate thereof taken into account to define the forecast trajectory in force up to the moment of the intervention.

10. The method according to claim 9, characterized in that the values that diverge from the estimate thereof comprise forecast values relating to instants subsequent to the instant of intervention.

11. The method according to claim 8, characterized in that it comprises:
updating at least one of the estimates according to a long-term trend observed or anticipated for at least one of the parameters, different from the preceding estimate taken into account for defining the forecast trajectory in force; and
definitively replacing the forecast trajectory with a new forecast trajectory taking into account the at least one updated estimate.

12. The method according to claim 1, characterized in that it comprises, during an episode of deviation (TE, TE1, TE2, TE3), allowing the temperature of the geothermal medium to diverge from the forecast trajectory (TP) in an exceptional situation relating to at least one of the parameters, or a combination of several of the parameters.

13. The method according to claim 12, characterized in that it comprises:
defining at the start of the episode the thermal power exchanged in the at least one probe so that the temperature of the geothermal medium diverges from the forecast trajectory (TP); and
defining for the temperature of the geothermal medium a deviation trajectory temporarily divergent from the forecast trajectory.

14. The method according to claim 12, characterized in that it comprises:
controlling the thermal power exchanged as a function of the actual demand with a degree of freedom with respect to the forecast trajectory (TP).

15. The method according to claim 12, characterized in that it comprises:
acquiring a forecast timing chart of the thermal power exchanged with the geothermal medium;
monitoring the at least approximate conformity of the evaluated mean temperature of the geothermal medium with a mean (TM) of the forecast trajectory (TP); and
in the case of drift of the evaluated mean temperature, amending at least indirectly the thermal power exchanged with the geothermal medium, with respect to the forecast timing chart, in a direction tending towards the return to conformity with one out of the mean temperature (TM) and the forecast trajectory (TP).

16. The method according to claim 1, characterized in that, as a function of parameters relating to the climate, to the sources and to the energy requirements of the installation, the regulating system (AUT, CU) commands a selective activation of the sources and of the items of equipment of the installation, as well as selective connections between sources and items of equipment, and carries out power regulation of the items of equipment, in the direction of satisfying the requirements and an optimization with respect to at least one criterion, said power regulation comprising said adjustment of the thermal power exchanged between the heat transfer fluid and the geothermal medium in the at least one probe.

17. The method according to claim 16, characterized in that the regulating system defines a succession over time of combinations of activation states of at least some of the items of equipment and of the sources over a duration subsequent to the current instant, in a direction of an optimization including the future, with respect to the at least one criterion.

18. The method according to claim 16, characterized in that the method comprises taking into account forecasts for at least one parameter chosen from: at least one price for energy originating from a source, and at least one climatic parameter out of the exterior temperature, sunshine and wind speed.

19. The method according to claim 1, characterized in that, before commissioning of the installation, tests of the thermal response of the geothermal medium to thermal exchanges are conducted by means of a test probe, so as to determine the thermal conductivity and the heating capacity of the geothermal medium.

20. The method according to claim 1, characterized in that the temperature of the heat transfer fluid at the inlet and at the outlet of the probes and the flow rate of the heat transfer fluid are measured, the flow rate and the difference between these two temperatures are used to calculate the thermal power exchanged with the geothermal medium, and the corresponding variation in the temperature of the geothermal medium is determined according to a prior modelling of the geothermal medium.

21. The method according to claim 1, characterized by regeneration phases during which thermal energy, hot or cold, supplied by the installation from another source connected to the installation is injected into the geothermal medium by means of the heat transfer fluid and the probes.

22. The method according to claim 1, characterized by regeneration phases during which unavoidable thermal energy, supplied by an item of equipment of the installation fed by one said other source is injected into the geothermal medium by means of the heat transfer fluid and the probes.

23. An installation for supplying thermal energy to a consuming structure, the installation comprising:
items of equipment for collecting energy (3, 4, CPh, CTh, ATh) that are in an energy exchange relationship with respective sources, these items of equipment comprising at least one geothermal probe in a thermal exchange relationship with a geothermal medium;
items of equipment for transforming energy (PAC, Comb, ELEC) at least partially fed by the items of collection equipment;
items of equipment that are users of energy, supplying energy to the structure; and
a regulating system (AUT, CU) capable of defining, for at least some of the different items of equipment, respective activation states chosen as a function of parameters, in particular climatic parameters, in the direction of an optimization with respect to at least one criterion; and
the regulating system implements the method according to claim 1.

24. A system for regulating an installation for supplying thermal energy to a consuming structure, the installation comprising:
items of equipment for collecting energy (3, 4, CPh, CTh, ATh) that are in an energy exchange relationship with respective sources, these items of equipment comprising at least one geothermal probe in a thermal exchange relationship with a geothermal medium;
items of equipment for transforming energy (PAC, Comb, ELEC) at least partially fed by the items of collection equipment; and
items of equipment that are users of energy, supplying energy to the structure;
the regulating system being capable of defining, for at least some of the items of equipment, different respective activation states chosen as a function of parameters, in particular climatic parameters, in the direction of an optimization with respect to at least one criterion; and
the regulating system implements the method according to claim 1.

25. The installation according to claim 23, characterized in that the regulating system (AUT, CU) comprises at least one input capable of receiving forecasts concerning a period subsequent to the current instant.
